(19) United States
(12) Patent Application Publication
(10) Pub. No.: US 2019/0071039 A1
(43) Pub. Date: Mar. 7, 2019

(54) IN-VEHICLE POWER SUPPLY DEVICE AND CONTROL METHOD FOR THE SAME

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Yoshiyuki Tsukamoto, Yokkaichi, Mie (JP)

(73) Assignees: AutoNetworks Technologies, Ltd., Yokkaichi, Mie (JP); SUMITOMO ELECTRIC INDUSTRIES, LTD., Osaka-shi, Osaka (JP); Sumitomo Wiring Systems, Ltd., Yokkaichi, Mie (JP)

(21) Appl. No.: 15/762,779

(22) PCT Filed: Sep. 21, 2016
(86) PCT No.: PCT/JP2016/077762

§ 371 Date: Mar. 23, 2018

(30) Foreign Application Priority Data
Sep. 25, 2015 (JP) 2015-187699

(51) Int. Cl. B60R 16/03; H02J 7/14; B60R 16/033; H02J 1/10

(52) U.S. Cl. CPC B60R 16/0307; H02J 1/10; B60R 16/033; H02J 7/1423

(57) ABSTRACT

Provided is a technology for supplying power to an external load while bypassing an overcurrent, even when a failure on a main battery side or a failure on a sub-battery side has occurred. One relay is connected to the main battery via another relay, and the sub-battery is connected to the main battery via both relays. A main power supply path connects the main battery to a backup load, bypassing both relays. A sub-power supply path connects the sub-battery and the backup load via one relay. The other relay transitions from a closed to an open state when an overcurrent flows thereto, and when the overcurrent flows in a charging direction, the one relay also transitions from a closed state to an open state. If the overcurrent flows in a direction opposite of the charging direction, the one relay does not transition from the closed to the open state.

### CROSS-REFERENCE TO RELATED APPLICATIONS

This application is the U.S. national stage of PCT/JP2016/0777672 filed Sep. 21, 2016, which claims priority of Japanese Patent Application No. JP 2015-187699 filed Sep. 25, 2015.

### TECHNICAL FIELD

This disclosure relates to an in-vehicle power supply device.

### BACKGROUND

In recent years, advances have been made in the electrification of vehicle loads. There are loads that receive power supply and are driven, even in the case where an engine has stopped in order to stop idling (provisionally referred to hereinafter as “at the time of ignition off”). These loads will hereinafter be referred to as idling stop loads (in the drawings, displayed as “IS load”). Navigation devices and audio devices are given as examples of idling stop loads.

FIG. 7 is a circuit diagram showing a configuration of a battery system in which an in-vehicle power supply device 200 supplies power to an idling stop load 7, in addition to a general load 5. The in-vehicle power supply device 200 is provided with a main battery (in the drawings, denoted as “Main BAT”) 1, a sub-battery (in the drawings, denoted as “Sub-BAT”) 2, and relays 201 and 202. The load 5 is connected to the main battery 1 without passing through the relays 201 and 202.

When the ignition is turned on and a starter 8 is driven, the main battery 1 is charged by a power generation function of an alternator 9. The sub-battery 2 is connected to the main battery 1 via the relays 201 and 202. The idling stop load 7 is connected to the main battery 1 via the relay 201, and to the sub-battery 2 via the relay 202. Such a technology is introduced in the following JP 2012-130108A.

Assume a case where a failure such as a ground fault occurs on the main battery 1 side of the relay 201. Normally, when an overcurrent is detected, the relays 201 and 202 are controlled to transition from a closed state to an open state to cut off this overcurrent. Therefore, if a case such as mentioned above is assumed, an overcurrent starts flowing from the sub-battery 2 via the relays 201 and 202, and the relay 202 enters the open state.

If the relay 202 thus enters the open state, power supply from the sub-battery 2 to the idling stop load 7 will stop. Because the failure has occurred on the main battery 1 side, power is not substantially supplied to the idling stop load 7, regardless of whether the relay 201 is in the closed state or the open state.

There are also electrified loads that perform functions relating to travelling, steering, and stopping. Therefore, loss of the battery function (including malfunction thereof; this similarly applies below) needs to be avoided. From this viewpoint, it is also desirable to employ a sub-battery as a backup power supply.

In view of this, an object of the present invention is to provide a technology for supplying power to an external load while avoiding the occurrence of an overcurrent, even in the case where a failure on the main battery side or a failure on the sub-battery side has occurred.

### SUMMARY

An in-vehicle power supply device is provided with a main battery and a sub-battery that are both for in-vehicle use, a first switch and a second switch, and a main power supply path and a sub-power supply path. The second switch is connected to the main battery via the first switch. The sub-battery is connected to the main battery via the first switch and the second switch. The main power supply path connects the main battery to a load, bypassing the first switch and the second switch. The sub-power supply path connects the sub-battery to the load via the second switch. The first switch transitions from on to off when an overcurrent flows thereto. If a direction of an overcurrent flowing to the first switch is a charging direction, the second switch transitions from on to off, and if a direction of the overcurrent flowing to the first switch is the opposite direction to the charging direction, the second switch does not transition from on to off. The charging direction is the direction in which a current flows to the first switch when the main battery charges the sub-battery.

The in-vehicle power supply device supplies power to the outside while avoiding the occurrence of an overcurrent, even in the case where a failure on the main battery side or a failure on the sub-battery side has occurred.

### BRIEF DESCRIPTION OF DRAWINGS

FIG. 1 is a circuit diagram showing an in-vehicle power supply device according to an embodiment.

FIG. 2 is a circuit diagram showing the in-vehicle power supply device according to the embodiment.

FIG. 3 is a circuit diagram showing the in-vehicle power supply device according to the embodiment.

FIG. 4 is a circuit diagram showing the in-vehicle power supply device according to the embodiment.

FIG. 5 is a circuit diagram showing the in-vehicle power supply device according to the embodiment.

FIG. 6 is a circuit diagram showing an in-vehicle power supply device according to a variation B.

FIG. 7 is a circuit diagram showing a conventional technology.

### DETAILED DESCRIPTION OF PREFERRED EMBODIMENTS

### Configuration

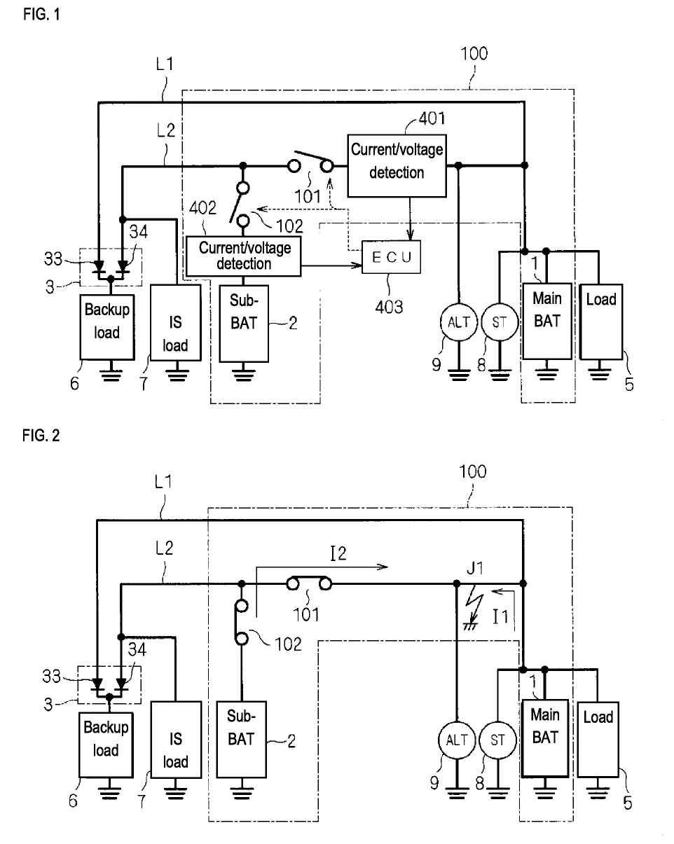

FIG. 1 is a circuit diagram showing an in-vehicle power supply device 100 according to an embodiment and elements connected thereto. The in-vehicle power supply device 100 is provided with a main battery 1, a sub-battery 2, relays 101 and 102, and circuits 401 and 402 that detect a current and a voltage (in the drawings, both written as “current/voltage detection”). An open state/closed state of the relays 101 and 102 is controlled by an in-vehicle ECU (Electronic Control Unit) 403. The in-vehicle ECU 403, for example, transitions the relays 101 and 102 between the open state and the closed state, in the case where an overvoltage or an overcurrent is detected in the circuits 401 and 402.

The main battery 1 and the sub-battery 2 are both for in-vehicle use, and the relay 101 and 102 are connected in series between both batteries. The relay 101 is connected to the main battery 1 via the circuit 401, and the relay 102 is connected to the main battery 1 via the relay 101 and the circuit 401. The relays 101 and 102 can be recognized as switches in which the closed state/open state corresponds to on/off respectively.

The main battery 1 is charged from the outside of the in-vehicle power supply device 100. Specifically, the main battery 1 is connected to an alternator 9 mounted in the vehicle, and is charged by a power generation function of the alternator 9. The sub-battery 2 is charged by at least one of the alternator 9 and the main battery 1 via the relays 101 and 102. For convenience of description given later, the direction in which a current flows to the relay 101 when the main battery 1 charges the sub-battery 2 is referred to as a “charging direction”.

A lead storage battery, for example, is employed for the main battery 1, and a lithium ion battery, for example, is employed for the sub-battery 2. The main battery 1 and the sub-battery 2 are both concepts that include a capacitor, and an electric double-layer capacitor can also be employed for the sub-battery 2, for example.

A starter 8 together with a general load 5 is connected to the main battery 1 from the outside of the in-vehicle power supply device 100. The load 5 is a load not to be backed up by the sub-battery 2, and is an in-vehicle air conditioner, for example. The starter 8 is a motor that starts an engine (not shown). Because the load 5 and the starter 8 are well-known loads and do not have characteristic features in the embodiment, a detailed description thereof is omitted.

A backup load 6 is a load to which power supply is desirably maintained even when power supply from the main battery 1 is lost, and a shift-by-wire actuator and an electronic brake force distribution system can be given as examples.

The in-vehicle power supply device 100 is further provided with a main power supply path L1 and a sub-power supply path L2, and supplies power to the backup load 6 via these paths. The main power supply path L1 connects the main battery 1, the load 5, and the backup load 6 in parallel between the main power supply path L1 and a fixed potential point (here, ground). That is, the load 5 and the backup load 6 both receive power via the main power supply path L1.

The main power supply path L1 connects the main battery 1 and the backup load 6 without passing through (i.e., bypassing) the relays 101 and 102. The sub-power supply path L2 is connected to the sub-battery 2 via the relay 102 and the circuit 402. Accordingly, the backup load 6 can receive power not only from the main battery 1 but also from the sub-battery 2.

A diode group 3 is interposed between the backup load 6 and the main power supply path L1 and sub-power supply path L2. The diode group 3 prevents sneak current between the main battery 1 and the sub-battery 2 flowing via the main power supply path L1 and the sub-power supply path L2. This sneak current causes degradation of one or both of the main battery 1 and the sub-battery 2.

Here, a case where both the main battery 1 and the sub-battery 2 supply power to the backup load 6 at a higher potential than ground is assumed. The cathodes of a pair of diodes 33 and 34 that constitute the diode group 3 are connected in common, and are connected to the backup load 6. The anode of the diode 33 is connected to the main power supply path L1, and the anode of the diode 34 is connected to the sub-power supply path L2. In this case, the above-mentioned charging direction is the direction in which a current flows from the main battery 1 to the sub-battery 2.

Because the diodes 33 and 34 are thus connected such that the forward directions are opposed, the above-mentioned sneak current is prevented. Moreover, power supply to the backup load 6 is possible from the main power supply path L1 via the diode 33 or from the sub-power supply path L2 via the diode 34.

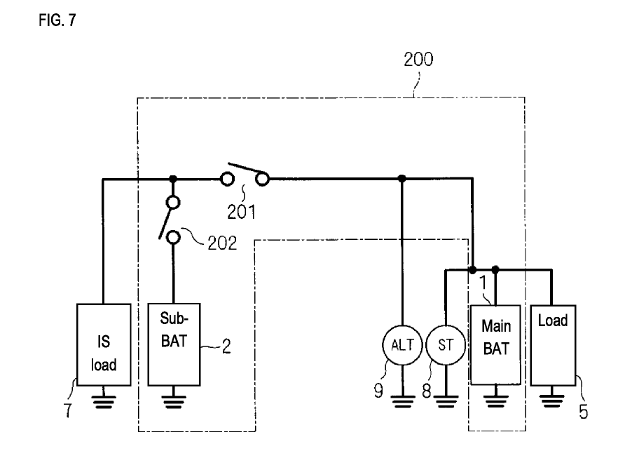

An idling stop load 7 is connected to the sub-power supply path L2, and is connected to the sub-battery 2 via the relay 102 and the circuit 402. Also, the idling stop load 7 is connected to the main battery 1 via the relay 101 and the circuit 401. That is, if the circuits 401 and 402 are excluded from consideration, the connection relationship of the idling stop load 7 with the relays 101 and 102 and with the main battery 1 and the sub-battery 2 in the present embodiment is similar to the connection relationship of the idling stop load 7 with the relays 201 and 202 and with the main battery 1 and the sub-battery 2 shown in FIG. 7.

The circuit 401 and the circuit 402 respectively detect the voltage of the main battery 1 (hereinafter, referred to as a “main voltage”) and the voltage of the sub-battery 2 (hereinafter, referred to as a “sub-voltage”). In the case where an overcurrent, which will be described later, has not occurred, the in-vehicle ECU 403 sets the open state/closed state of the relays 101 and 102 as follows.

If the sub-voltage is low to the extent that it is judged that the sub-battery 2 needs to be charged, the relays 101 and 102 are both set to the closed state, and the sub-battery 2 is charged with the main battery 1 and/or the alternator 9. If the sub-voltage is high to the extent that it is judged that charging of the sub-battery 2 is excessive, the relay 101 is set to the open state and charging of the sub-battery 2 is stopped. At this time, if the relay 102 is set to the closed state, power is supplied to the backup load 6 from the main power supply path L1 or the sub-power supply path L2 depending on the magnitude relationship between the main voltage and the sub-voltage.

When the sub-battery 2 is not charged, the closed state/open state of the relay 102 is selected according to the operation. In the present embodiment, such selection of the closed state/open state of the relay 102 when not charging the sub-battery 2 is not essential in the normal operation. Therefore, a detailed description regarding this selection is omitted.

The circuit 401 detects a current flowing to the relay 101 (hereinafter, referred to as a “first current”) including the flow direction of the current. As will be mentioned later, this is for comprehending whether the flow direction of the first current is the charging direction or the opposite direction to the charging direction. The charging direction is determined by a polarity with respect to the ground potential of a potential of power that the main battery 1 and the sub-battery 2 supplies. Accordingly, if a configuration of the main battery 1 and the sub-battery 2 employed in the in-vehicle power supply device 100 is known, the charging direction is also known, and the direction in which the first current flows can be comprehended from the polarity of the first current.

For example, if the main battery 1 and the sub-battery 2 supply power at a positive potential with respect to the ground potential, the charging direction is, as above-mentioned, the direction from the main battery 1 to the sub-battery 2. In this case, if the direction from the main battery 1 to the sub-battery 2 is taken as being positive and the first current is detected, when the first current has a positive value, the direction in which the first current flows is the charging direction. Also, when the first current has a negative value, the direction in which the first current flows is the opposite direction to the charging direction.

On the other hand, in this case, if the direction from the sub-battery 2 to the main battery 1 is taken as being positive and the first current is detected, when the first current has a negative value, the direction in which the first current flows is the charging direction. Also, when the first current has a positive value, the direction in which the first current flows is the opposite direction to the charging direction.

Also, if the main battery 1 and the sub-battery 2 supply power at a negative potential with respect to the ground potential, the charging direction is the direction from the sub-battery 2 to the main battery 1. In this case, if the direction from the main battery 1 to the sub-battery 2 is taken as being positive and the first current is detected, when the first current has a negative value, the direction in which the first current flows is the charging direction. Also, when the first current has a positive value, the direction in which the first current flows is the opposite direction to the charging direction. On the other hand, if the direction from the sub-battery 2 to the main battery 1 is taken as being positive and the first current is detected, when the first current has a positive value, the direction in which the first current flows is the charging direction. Also, when the first current has a negative value, the direction in which the first current flows is the opposite direction to the charging direction.

Note that, in this case, the anodes of the diodes 33 and 34 of the diode group 3 are connected in common to the backup load 6, the cathode of the diode 33 is connected to the main power supply path L1, and the cathode of the diode 34 is connected to the sub-power supply path L2.

If it is judged that (the absolute value of) the first current is an overcurrent, the in-vehicle ECU 403 sets the relay 101 to the open state, even at the time of charging the sub-battery 2. The circuit 402 detects a current flowing to the relay 102 (hereinafter, referred to as a “second current”).

### Operation

Hereinafter, to avoid complexity in the drawings, circuit diagrams that omit the circuits 401 and 402 and the in-vehicle ECU 403 from FIG. 1 are used in FIGS. 2 to 5, in describing the operation of the present embodiment.

FIG. 2 is a circuit diagram showing a situation in which a ground fault J1 has occurred on the main battery 1 side of the relay 101 (of the circuit 401, more precisely), when the relays 101 and 102 are in the closed state. Due to the ground fault J1, a current I2 also flows to ground from the sub-battery 2 via the relays 101 and 102, in addition to a current I1 flowing to ground from the main battery 1. This similarly applies in the case where a ground fault occurs on the main power supply path L1. The current I2 is a ground fault current and flows not only as the second current but also as the first current. Accordingly, the circuits 401 and 402 detect both the first current and the second current as overcurrents.

In such a state, both the main battery 1 and the sub-battery 2 are short-circuited by the ground fault J1, and power cannot be supplied from either the main power supply path L1 or the sub-power supply path L2. However, if the relays 101 and 102 are both set to the open state, power supply from the sub-power supply path L2 is no longer performed continuously.

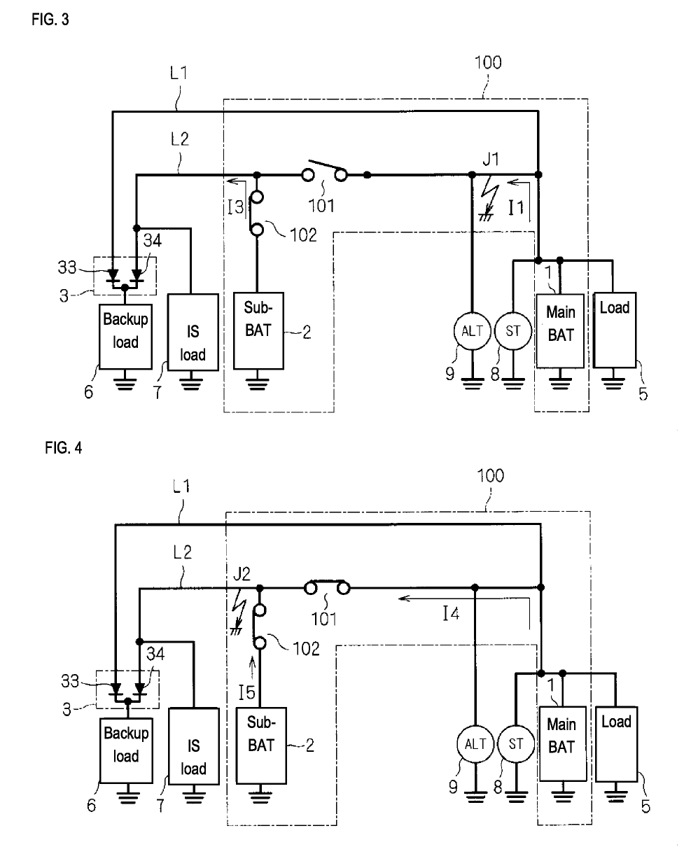

The current I2 flows in the opposite direction to the charging direction as the first current. In the present embodiment, in the case where such an overcurrent that flows in the opposite direction to the charging direction is detected as the first current, it is judged that a ground fault has not occurred on the sub-power supply path L2, and the relay 101 transitions from the closed state to the open state while the relay 102 remains in the closed state. As a result, by the function of the diode group 3, the sub-battery 2 is cut off from the ground fault J1 as shown in FIG. 3, and the current I2, which is a ground fault current, does not flow. Instead, a current I3 flows from the sub-battery 2 through the sub-power supply path L2. Because the current I3 is not a ground fault current, the circuit 402 does not judge that the second current is an overcurrent, and accordingly the relay 102 maintains the closed state.

Accordingly, power is supplied to the backup load 6 and the idling stop load 7 through the sub-power supply path L2 with the current I3. That is, the sub-battery 2 functions as a backup power supply for the backup load 6. Even in the case where a failure thus occurs on the main battery 1 side, power supply to the outside is secured while avoiding the occurrence of an overcurrent.

FIG. 4 is a circuit diagram showing a situation in which a ground fault J2 has occurred on the opposite side to the main battery 1 and the sub-battery 2 with respect to the relays 101 and 102, or in other words, on the sub-power supply path L2, when the relays 101 and 102 are in the closed state. Due to the ground fault J2, a current I4 flows from the main battery 1 to ground via the relay 101, and a current I5 flows from the sub-battery 2 to ground via the relay 102. The currents I4 and I5 are ground fault currents, and respectively flow as the first current and the second current. Accordingly, the circuits 401 and 402 detect both the first current and the second current as overcurrents.

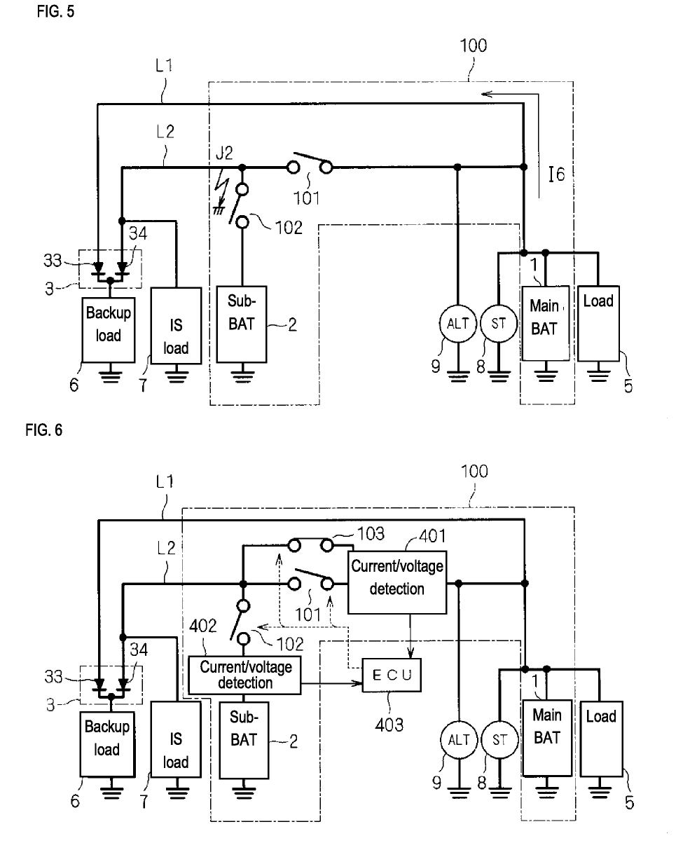

The current I4 flows in the charging direction as the first current. In the present embodiment, in the case where an overcurrent that flows in the charging direction is detected as the first current, it is judged that a ground fault has occurred in the sub-power supply path L2, and both the relays 101 and 102 transition from the closed state to the open state. As a result, by the function of the diode group 3, the main battery 1 and the sub-battery 2 are cut off from the ground fault J2 as shown in FIG. 5. Because the main power supply path L1 is connected to the backup load 6, bypassing both the relays 101 and 102, a current I6 flows through the main power supply path L1 from the main battery 1.

Accordingly, power is supplied to the backup load 6 through the main power supply path L1 with the current I6. That is, the main battery 1 functions as a backup power supply for the backup load 6. Even in the case where a failure thus occurs on the sub-battery 2 side, power supply to the outside is secured while avoiding the occurrence of an overcurrent.

Note that, after an overcurrent has been detected as the first current and once the relay 101 has entered the open state, the relay 101 is not transitioned to the closed state even when an overcurrent is not detected as the first current. This is to prevent the current I2 or I4 from flowing as a ground fault current again.

It is evident from the above that the following processing will be successful, in the case where only one of a failure on the main battery 1 side (typically the above-mentioned ground fault J1) and a failure on the sub-battery 2 side (typically the above-mentioned ground fault J2) occurs. This can be recognized as a method of controlling the in-vehicle power supply device 100.

In a situation where both the relays 101 and 102 are in the closed state:
(i) if it is detected that the first current is an overcurrent flowing in the charging direction, the relays 101 and 102 transition from the closed state to the open state; and
(ii) if it is detected that the first current is an overcurrent flowing in the opposite direction to the charging direction, the relay 101 transitions from the closed state to the open state, whereas the relay 102 maintains the closed state.

In the case where only the ground fault J2 occurs, the operation (i) is executed, but the operation (ii) is not executed. Also, in the case where only the ground fault J1 occurs, the operation (i) is not executed, but the operation (ii) is executed.

The in-vehicle ECU 403 is configured to include, for example, a microcomputer and a storage device. The microcomputer executes processing steps (in other words, procedures) described in computer programs. The above-mentioned storage device can be constituted by one or a plurality of types of storage devices such as a ROM (Read Only Memory), a RAM (Random Access Memory), and a rewritable nonvolatile memory including an EPROM (Erasable Programmable ROM), for example. The storage device stores various types of information, data and the like, stores programs that the microcomputer executes, and provides a work area for the microcomputer to execute the programs. Note that it can be recognized that the microcomputer functions as various means corresponding to the processing steps described in the programs, or realizes various functions corresponding to the processing steps. Also, the in-vehicle ECU 403 is not limited thereto, and the various procedures executed by the in-vehicle ECU 403, or the various means or various functions realized by the in-vehicle ECU 403 may be partly or entirely realized with hardware.

Also, a circuit that controls the above-mentioned relays 101 and 102 may be incorporated in either the relay 101 or the relay 102.

### Variation A

Even if the ground fault J1 or J2 occurs, not only the first current but also the second current flows as an overcurrent. Accordingly, there is a possibility that the relay 102 transitions from the closed state to the open state before the relay 101 transitions from the closed state to the open state (hereinafter, referred to as a “reverse operation”).

If the reverse operation occurs when the ground fault J1 occurs, the first current does not flow, thus the relay 101 maintains the closed state. However, for the reason mentioned in “Technical Problem”, even if the relay 101 maintains the closed state, power is not supplied from the main battery 1 via the sub-power supply path 2.

Accordingly, it is desirable that a judgment as to whether or not an overcurrent has flowed to the relay 101 within a predetermined period (i.e., a judgment as to whether or not the first current has been detected as an overcurrent) after an overcurrent begins to flow to the relay 102 (i.e., after the second current is detected as an overcurrent) is performed before the relay 102 transitions from the closed state to the open state.

More specifically, the relay 102 maintains the closed state for a predetermined period after an overcurrent begins to flow to the relay 102, and then the relay 102 transitions from the closed state to the open state if an overcurrent does not flow to the relay 101 within the predetermined period.

This makes it possible not only to avoid the reverse operation but also to protect the sub-battery 2 from a failure due to causes other than the ground faults J1 and J2.

### Variation B

At the time of ignition off, the power generation function by the alternator 9 cannot be expected, and charging of the main battery 1 also cannot be expected. Accordingly, from the viewpoint of cutting off the charging path from the main battery 1 to the sub-battery 2, it is desirable to separate the main battery 1 and the sub-battery 2. Therefore, it is desirable that a normally-open relay is employed for the relays 101 and 102. In the case where the relays 101 and 102 are recognized as switches, the normally-open relays can be recognized as normally-off switches.

On the other hand, it is desirable to supply power to the idling stop load 7 even at the time of ignition off. Therefore, as shown in FIG. 6, it is desirable that a normally-closed relay 103 is connected in parallel to the relay 101. This is in order to secure power supply from the main battery 1 to the idling stop load 7 via the sub-power supply path L2 even at the time of ignition off. If the relay 103 is recognized as a switch, the normally-closed relay can be recognized as a normally-on switch.

In this case, even if the normally-open relays 101 and 102 enter the open state due to a malfunction or a failure of the in-vehicle ECU 403, power supply from the main battery 1 to the idling stop load 7 via the sub-power supply path L2 is also secured because the normally-closed relay 103 is in the closed state.

However, it is desirable that the relay 103 transitions to the open state in accordance with transition of the relay 101 from the closed state to the open state so as not to prevent the effect of the relay 101 transitioning to the open state in the above-mentioned operations (i) and (ii).

The configurations described in the above embodiment, variation A, and variation B can be appropriately combined as long as there are no mutual inconsistencies.

Although the invention has been described in detail above, the foregoing description is, in all respects, illustrative, and the invention is not limited to that description. It should be understood that innumerable variations that are not illustrated herein can be conceived without departing from the scope of the invention.

1. An in-vehicle power supply device comprising:
a main battery for in-vehicle use;
a first switch configured to transition from on to off when an overcurrent flows thereto;
a second switch that is connected to the main battery via the first switch and is configured to transition from on to off if a direction of the overcurrent flowing to the first switch is a charging direction, and to not transition from on to off if the direction of the overcurrent flowing to the first switch is the opposite direction to the charging direction;
a sub-battery for in-vehicle use that is connected to the main battery via the first switch and the second switch;
a main power supply path that connects the main battery to a load, bypassing the first switch and the second switch; and
a sub-power supply path that connects the sub-battery to the load via the second switch,
wherein the charging direction is the direction in which a current flows to the first switch when the main battery charges the sub-battery.

2. The in-vehicle power supply device according to claim 1,
wherein the second switch maintains an on state for a predetermined period after an overcurrent begins to flow thereto, and if an overcurrent does not flow to the first switch within the predetermined period, the second switch transitions from on to off.

3. The in-vehicle power supply device according to claim 1, further comprising:
a normally-on third switch connected in parallel to the first switch,
wherein the first switch and the second switch are normally-off switches, and
the third switch transitions to off with transition of the first switch from on to off.

4. A control method for an in-vehicle power supply device that includes:
a main battery for in-vehicle use;
a first switch;
a second switch that is connected to the main battery via the first switch;
a sub-battery for in-vehicle use that is connected to the main battery via the first switch and the second switch;
a main power supply path that connects the main battery to a load, bypassing the first switch and the second switch; and
a sub-power supply path that connects the sub-battery to the load via the second switch,
the method comprising:
causing the first switch to transition from on to off if an overcurrent flows to the first switch; and
causing the second switch to transition from on to off if a direction of the overcurrent flowing to the first switch is a charging direction, and not causing the second switch to transition from on to off if the direction of the overcurrent flowing to the first switch is the opposite direction to the charging direction,
wherein the charging direction is the direction in which a current flows to the first switch when the main battery charges the sub-battery.

5. The control method for an in-vehicle power supply device according to claim 4,
wherein the second switch is maintained in an on state for a predetermined period after an overcurrent begins to flow thereto, and if an overcurrent does not flow to the first switch within the predetermined period, the second switch is transitioned from on to off.

6. The control method for an in-vehicle power supply device according to claim 4,
wherein the in-vehicle power supply device further includes:
a normally-on third switch connected in parallel to the first switch,
the first switch and the second switch are normally-off switches, and
the third switch is transitioned to off with transition of the first switch from on to off.

7. The in-vehicle power supply device according to claim 2, further comprising:
a normally-on third switch connected in parallel to the first switch,
wherein the first switch and the second switch are normally-off switches, and
the third switch transitions to off with transition of the first switch from on to off.

8. The control method for an in-vehicle power supply device according to claim 5, wherein the in-vehicle power supply device further includes:
a normally-on third switch connected in parallel to the first switch,
the first switch and the second switch are normally-off switches, and
the third switch is transitioned to off with transition of the first switch from on to off.
